(19) United States
(12) Patent Application Publication
(10) Pub. No.: US 2014/0184935 A1
(43) Pub. Date: Jul. 3, 2014

(54) TOUCH PANEL

(71) Applicant: SAMSUNG ELECTRO-MECHANICS CO., LTD., Suwon (KR)

(72) Inventors: Jae Hun Kim, Suwon (KR); Sang Su Hong, Suwon (KR); Jin Uk Lee, Suwon (KR)

(73) Assignee: SAMSUNG ELECTRO-MECHANICS CO., LTD., Suwon (KR)

(21) Appl. No.: 13/845,076

(22) Filed: Mar. 17, 2013

(30) Foreign Application Priority Data
Dec. 28, 2012 (KR) 10-2012-0157263

(51) Int. Cl. G02F 1/1333

(52) U.S. Cl. CPC G02F 1/133308
USPC 349/12

(57) ABSTRACT

Disclosed herein is a touch panel including: a window substrate; at least one transparent substrate including electrode patterns and electrode windings in a bezel part region provided on one surface thereof in one surface direction of the window substrate, the electrode windings in the bezel part region being connected to the electrode patterns; and a color bezel part provided in the bezel part region between the window substrate and the transparent substrate. In the touch panel, the color bezel part has a stacked structure in which it includes a first ultraviolet (UV) absorbing layer, a first color light layer, a second color light layer, a light filter layer, a third color light layer, a second UV absorbing layer, and an overcoating layer that are sequentially disposed in one surface direction of the window substrate.

### CROSS REFERENCE TO RELATED APPLICATION

This application claims the benefit of Korean Patent Application No. 10-2012-0157263, filed on Dec. 28, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

In accordance with the rapid advancement of an information-oriented society, the use of computers has gradually been widened; however, it is difficult to efficiently operate products using only a keyboard and a mouse currently serving as an input device.

Therefore, the necessity for a device that is simple, has less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) and is used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, the touch panel according to the related art includes a bezel part formed in a decoration pattern in order to hide an electrode wiring, or the like, as disclosed in US Patent Laid-Open Publication No. 2011/0115723.

However, the bezel part has been implemented by only a single color such as a black color or a white color. Therefore, a user's demand for a bezel part implemented by a symbol or an image having various colors has increased.

### PRIOR ART DOCUMENT

### Patent Document

(Patent Document 1) US Patent Laid-Open Publication No. 2011/0115723 (published on May 19, 2011)

### SUMMARY OF THE INVENTION

The present invention has been made an effort to provide a touch panel having a bezel part implemented by a symbol or an image having various colors.

According to a preferred embodiment of the present invention, there is provided a touch panel including: a window substrate; at least one transparent substrate including electrode patterns and electrode windings in a bezel part region provided on one surface thereof in one surface direction of the window substrate, the electrode windings in the bezel part region being connected to the electrode patterns; and a color bezel part provided in the bezel part region between the window substrate and the transparent substrate.

The color bezel part may have a stacked structure in which it includes a first ultraviolet (UV) absorbing layer, a first color light layer, a second color light layer, a light filter layer, a third color light layer, a second UV absorbing layer, and an overcoating layer that are sequentially disposed in one surface direction of the window substrate.

The first and second UV absorbing layers may be made of a UV blocking inorganic material or a UV blocking organic material.

The light filtering layer may be a filter layer for blocking blue color light.

Each of the first color light layer, the second color light layer, and the third color light layer may be provided in a form in which a dye having any one of a magenta color, a yellow color, and a cyan color is contained in a silver salt emulsion layer including silver salt and a binder.

The silver salt may be inorganic silver salt including silver halide or organic silver salt including acetic acid silver.

The binder may include at least one selected from a group consisting of gelatin, polyvinyl alcohol (PVA), polyvinyl pyrrolidone (PVP), polysaccharides including starch, cellulose and derivatives thereof, polyethylene oxide, polyvinyl amine, chitosan, polylysine, polyacrylic acid, poly-alginic acid, poly hyaluronic acid, carboxy cellulose, or a combination thereof.

Each of the first color light layer, the second color light layer, and the third color light layer may be provided in a form in which any one of a red dye, a green dye, and a blue dye contained in a silver salt emulsion layer including silver salt and a binder.

The window substrate may include a window glass.

The window substrate may have any one of a hard coating layer, an anti-finger layer, and an anti-glare layer or a stacked structure of a combination thereof, formed on an outer surface of the window glass.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch panel according to a first preferred embodiment of the present invention;

FIG. 2 is a cross-sectional view of a touch panel according to a second preferred embodiment of the present invention;

FIG. 3 is an illustrative cross-sectional view for describing color implementation of a color bezel part of the touch panel according to the first preferred embodiment of the present invention; and

FIG. 4 is an illustrative cross-sectional view for describing color implementation of a color bezel part of the touch panel according to the second preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

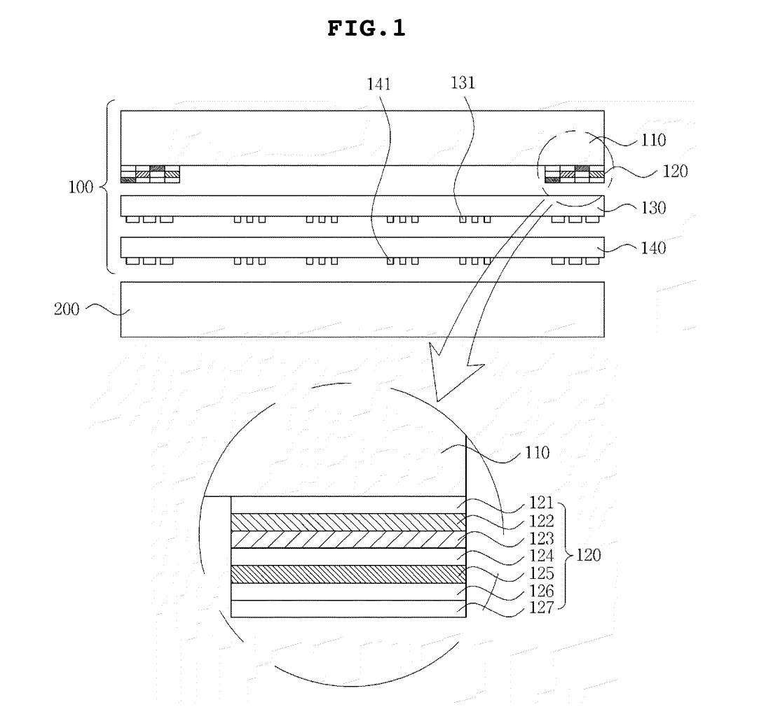

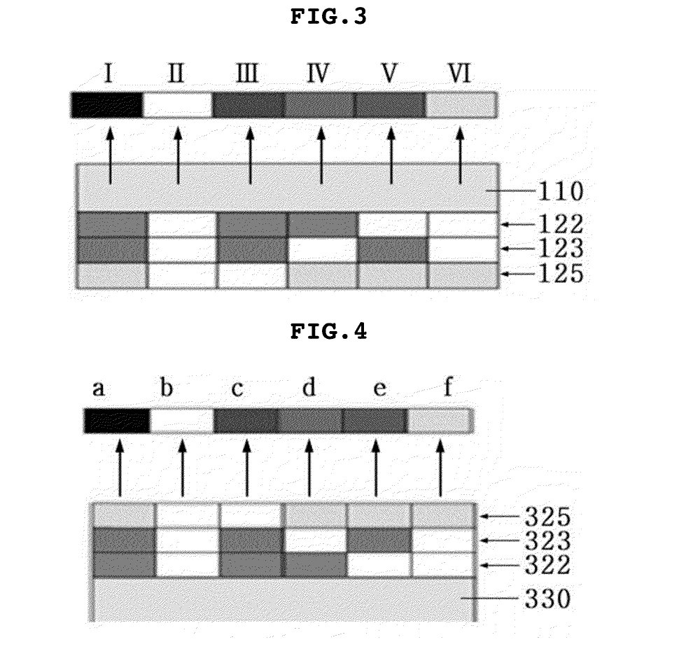

FIG. 1 is a cross-sectional view of a touch panel according to a first preferred embodiment of the present invention; and FIG. 3 is an illustrative cross-sectional view for describing color implementation of a color bezel part of the touch panel according to the first preferred embodiment of the present invention. Here, although the case in which the touch panel 100 according to the first preferred embodiment of the present invention is attached onto a display panel 200 such as a liquid crystal display (LCD) panel and includes a color bezel part 120 implemented integrally with a window substrate 110 is shown and describe, the touch panel is not limited thereto, but may be implemented in various forms.

The touch panel 100 according to the first preferred embodiment of the present invention is configured to include the window substrate 110; the color bezel part 120 provided in a bezel part region of the window substrate 110; a first transparent substrate 130 including first electrode patterns 131 and electrode wirings in the bezel part region provided on one surface thereof in a direction in which the color bezel part 120 is formed, the electrode wirings in the bezel part region being connected to the first electrode patterns 131; and a second transparent substrate 140 including second electrode patterns 141 and electrode wirings in the bezel part region provided on one surface thereof, the electrode wirings in the bezel part region being connected to the second electrode patterns 141.

The window substrate 110, which is a substrate made of a transparent material such as a window glass, or the like, is provided at the outermost portion of the touch panel 100 and receives a touch of a user. Here, the window substrate 110 may have any one of a hard coating layer, an anti-finger layer, and an anti-glare layer or a stacked structure of a combination of at least two thereof, formed on an outer surface thereof.

The color bezel part 120, which is a multilayer structure provided in the bezel part region of the window substrate 110 to implement various colors, includes a first ultraviolet (UV) absorbing layer 121, a first color light layer 122, a second color light layer 123, a light filter layer 124, a third color light layer 125, a second UV absorbing layer 126, and an overcoating layer 127 that are sequentially disposed in one surface direction of the window substrate 110.

More specifically, the first and second UV absorbing layers 121 and 126 may be made of a UV blocking inorganic material or a UV blocking organic material in order to prevent colors of the first color light layer 122, the second color light layer 123, and the third color light layer 125 from being changed due to UV. Here, the UV blocking inorganic material may be a metal oxide such as indium tin oxide, titanium dioxide, or the like, and the UV blocking organic material may be benzophenone, benzotriazole, salicylic acid, acrylonitrile, an organic nickel compound, or the like. However, the above-mentioned materials are only examples, and the present invention is not limited thereto.

The first color light layer 122, the second color light layer 123, and the third color light layer 125 may implement the respective lights according to a three primary color principle of light and implement various colors by mixing the respective lights with each other by a subtractive mixture method or an additive color mixture method.

For example, in the case in which the first color light layer 122, the second color light layer 123, and the third color light layer 125 implement various colors by the subtractive mixture method, they may be provided in a form in which a dye having any one of a magenta color, a yellow color, and a cyan color is contained in a silver salt emulsion layer including silver salt and a binder, respectively.

Here, the silver salt may be inorganic silver salt such as silver halide (AgCl, AgBr, AgF, AgI), or the like, or organic silver salt such as acetic acid silver, or the like, and the binder, which uniformly disperses the silver salt and enhances adhesion, may be gelatin, polyvinyl alcohol (PVA), polyvinyl pyrrolidone (PVP), polysaccharides such as starch, or the like, cellulose and derivatives thereof, polyethylene oxide, polyvinyl amine, chitosan, polylysine, polyacrylic acid, poly-alginic acid, poly hyaluronic acid, carboxy cellulose, or the like. This binder has a natural property, an anionic property, or a cationic property according to ionicity of a functional group.

The first color light layer 122, the second color light layer 123, and the third color light layer 125 contain a dye having any one of a magenta color, a yellow color, and a cyan color, respectively, thereby making it possible to implement various colors to the outside through the window substrate 110 as shown in FIG. 3.

For example, as shown in FIG. 3, in a form in which the first color light layer 122, containing the dye of the cyan color, the second color light layer 123 containing the dye of the magenta color, and the third color light layer 125 containing the dye of the yellow color, implemented colors are determined according to whether or not each dye is present.

That is, a block color is implemented in a region I in which all of the dyes are present, a white color is implemented in a region II in which all of the dyes are not present, a blue color is implemented in a region III by the dye of the cyan color and the dye of the magenta color, a green color is implemented in a region IV by the dye of the cyan color and the dye of the yellow color, a red color is implemented in a region V by the dye of the magenta color and the dye of the yellow color, and a yellow color is implemented in a region VI in which only the dye of the yellow color is present.

Therefore, the color bezel part 120 may implement various colors to the outside in each region to display a symbol or an image having various colors to the user.

Here, although the case in which each of the first color light layer 122, the second color light layer 123, and the third color light layer 125 is a silver salt emulsion layer containing the dye having any one of the magenta color, the yellow color, and the cyan color in order for the color bezel part 120 to implement various colors by the subtractive mixture method has been described, the present invention is not limited thereto. That is, each of the first color light layer 122, the second color light layer 123, and the third color light layer 125 may be provided as a silver salt emulsion layer containing any one of a red dye, a green dye, and a blue dye in order to implement various colors by the additive color mixture method.

In addition, the light filter layer 124 may be provided between the second color light layer 123 and the third color light layer 125 in order to selectively block blue color light.

The first and second transparent substrates 130 and 140 serve to provide regions in which the electrode patterns 131 and 141, the electrode wirings in a bezel part region, and the like, are to be formed, respectively. Here, each of the first and second transparent substrates 130 and 140 should have support force capable of supporting the electrode patterns 131 and 141, the electrode wirings, and the like, and transparency capable of allowing the user to recognize an image provided by an image display device.

In consideration of the support force and the transparency described above, the first and second transparent substrates 130 and 140 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto.

The first and second electrode patterns 131 and 141 serve to generate signals at the time of being touched by the user to allow a controller to recognize a touch coordinate. Here, the first and second electrode patterns 131 and 141 may be formed in a mesh pattern using copper (Cu), aluminum (Al), gold (Au), silver (Ag), titanium (Ti), palladium (Pd), chromium (Cr), or a combination thereof.

More specifically, the first and second electrode patterns 131 and 141 are, preferably, made of copper (Cu), aluminum (Al), gold (Au), silver (Ag) having high electrical conductivity. However, the first and second electrode patterns 131 and 141 may be made of any metal having electrical conductivity.

Further, in the case in which the first and second electrode patterns 131 and 141 are made of copper (Cu), it is preferable that surfaces of the first and second electrode patterns 131 and 141 are black-oxidized. Here, the black-oxidation indicates a process in which Cu₂O or CuO is precipitated by oxidizing the surfaces of the electrode patterns 131 and 141, wherein the Cu₂ is brown and is thus referred to as a brown oxide and the CuO is black and is thus referred to as a black oxide.

As described above, the surfaces of the electrode patterns 131 and 141 are black-oxidized to prevent light from being reflected, thereby making it possible to improve visibility of the touch panel 100.

The first and second electrode patterns 131 and 141 may be made of silver formed by exposing and developing the silver salt emulsion layer, indium tin oxide (ITO), PEDOT/PSS, carbon nanotube (CNT), graphene, zinc oxide (ZnO), or al-doped zinc oxide (AZO), or the like, in addition to the above-mentioned metals.

In addition, the first and second electrode patterns 131 and 141 may be formed in all patterns known in the art, such as a rod shaped pattern, a diamond shaped pattern, a rectangular pattern, a triangular pattern, a circular pattern, and the like.

The touch panel 100 according to the first preferred embodiment of the present invention configured as described above includes the color bezel part 120 disposed in the bezel part region of the window substrate 110 and having a multi-layer structure to implement various colors by mixing the colors with each other by the subtractive mixture method or the additive color mixture method, thereby making it possible to implement the symbol and the image having various colors in the bezel part.

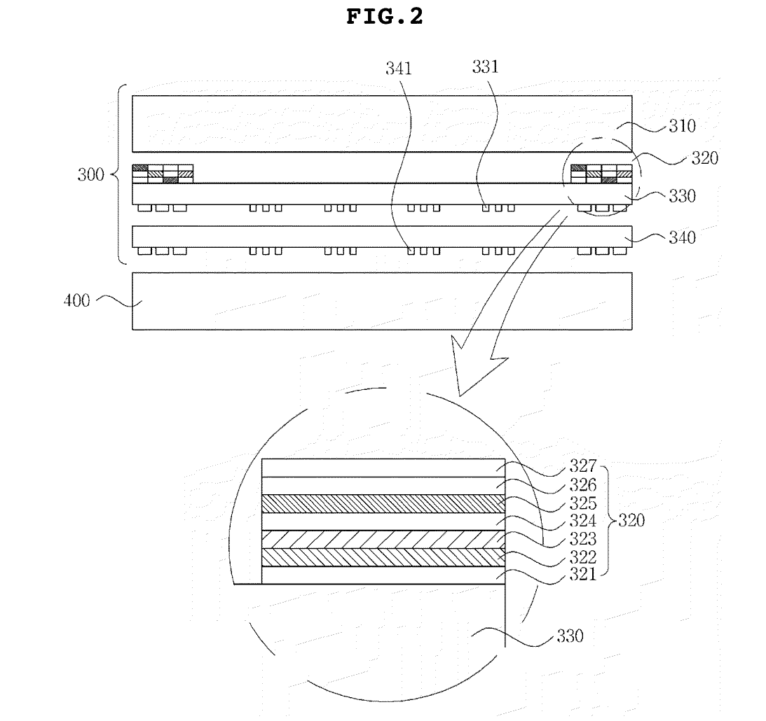

Hereinafter, a touch panel 300 according to a second preferred embodiment of the present invention will be described with reference FIGS. 2 and 4. FIG. 2 is a cross-sectional view of a touch panel according to a second preferred embodiment of the present invention; and FIG. 4 is an illustrative cross-sectional view for describing color implementation of a color bezel part of the touch panel according to the second preferred embodiment of the present invention.

The touch panel 300 according to the second preferred embodiment of the present invention is configured to include a window substrate 310; a first transparent substrate 130 including first electrode patterns 331 and electrode wirings in a bezel part region provided on one surface thereof, the electrode wirings in the bezel part region being connected to the first electrode patterns 331; a color bezel part 320 provided in the bezel part region between the window substrate 310 and the first transparent substrate 330; and a second transparent substrate 340 corresponding to the first transparent substrate 330 and including second electrode patterns 341 and electrode wirings in the bezel part region provided on one surface thereof, the electrode wirings in the bezel part region being connected to the second electrode wirings 341.

The window substrate 310, which is a substrate made of a transparent material such as a window glass, or the like, is provided at the outermost portion of the touch panel 300 and receives a touch of a user. Here, the window substrate 310 may have any one of a hard coating layer, an anti-finger layer, and an anti-glare layer or a stacked structure of a combination of at least two thereof formed on an outer surface thereof.

The color bezel part 320, which is a multilayer structure provided in the bezel part region between the window substrate 310 and the first transparent substrate 330 to implement various colors, includes a first UV absorbing layer 321, a first color light layer 322, a second color light 323, a light filter layer 324, a third color light layer 325, a second UV absorbing layer 326, and an overcoating layer 327 that are sequentially disposed from the first transparent substrate 330.

More specifically, the first and second UV absorbing layers 321 and 326 may be made of a UV blocking inorganic material or a UV blocking organic material in order to prevent colors of the first color light layer 322, the second color light layer 323, and the third color light layer 325 from being changed due to UV. Here, the UV blocking inorganic material may be a metal oxide such as indium tin oxide, titanium dioxide, or the like, and the UV blocking organic material may be benzophenone, benzotriazole, salicylic acid, acrylonitrile, an organic nickel compound, or the like. However, the above-mentioned materials are only examples, and the present invention is not limited thereto.

The first color light layer 322, the second color light layer 323, and the third color light layer 325 may implement the respective lights according to a three primary color principle of light and implement various colors by mixing the respective lights with each other by a subtractive mixture method or an additive color mixture method.

For example, in the case in which the first color light layer 322, the second color light layer 323, and the third color light layer 325 implement various colors by the subtractive mixture method, they may be provided in a form in which a dye having any one of a magenta color, a yellow color, and a cyan color is contained in a silver salt emulsion layer including silver salt and a binder, respectively.

Here, the silver salt may be inorganic silver salt such as silver halide (AgCl, AgBr, AgF, AgI), or the like, or organic silver salt such as acetic acid silver, or the like, and the binder, which uniformly disperses the silver salt and enhances adhesion, may be gelatin, polyvinyl alcohol (PVA), polyvinyl pyrrolidone (PVP), polysaccharides such as starch, or the like, cellulose and derivatives thereof, polyethylene oxide, polyvinyl amine, chitosan, polylysine, polyacrylic acid, poly-alginic acid, poly hyaluronic acid, carboxy cellulose, or the like. This binder has a natural property, an anionic property, or a cationic property according to ionicity of a functional group.

The first color light layer 322, the second color light layer 323, and the third color light layer 325 contain a dye having any one of a magenta color, a yellow color, and a cyan color, respectively, thereby making it possible to implement various colors to the outside through the window substrate 310 as shown in FIG. 4.

For example, as shown in FIG. 4, in a form in which the first color light layer 322, containing the dye of the cyan color, the second color light layer 323 containing the dye of the magenta color, and the third color light layer 325 containing the dye of the yellow color, implemented colors are determined according to whether or not each dye is present.

That is, a block color is implemented in a region a in which all of the dyes are present, a white color is implemented in a region b in which all of the dyes are not present, a blue color is implemented in a region c by the dye of the cyan color and the dye of the magenta color, a green color is implemented in a region d by the dye of the cyan color and the dye of the yellow color, a red color is implemented in a region e by the dye of the magenta color and the dye of the yellow color, and a yellow color is implemented in a region fin which only the dye of the yellow color is present.

Therefore, the color bezel part 320 may implement various colors to the outside in each region to display a symbol or an image having various colors to the user.

Here, although the case in which each of the first color light layer 322, the second color light layer 323, and the third color light layer 325 is a silver salt emulsion layer containing the dye having any one of the magenta color, the yellow color, and the cyan color in order for the color bezel part 320 to implement various colors by the subtractive mixture method has been described, the present invention is not limited thereto. That is, each of the first color light layer 322, the second color light layer 323, and the third color light layer 325 may be provided as a silver salt emulsion layer containing any one of a red dye, a green dye, and a blue dye in order to implement various colors by the additive color mixture method.

In addition, the light filter layer 324 may be provided between the second color light layer 323 and the third color light layer 325 in order to selectively block blue color light.

The first and second transparent substrates 330 and 340 serve to provide regions in which the electrode patterns 331 and 341, the electrode wirings in a bezel part region, and the like, are to be formed, respectively. Here, each of the first and second transparent substrates 330 and 340 should have support force capable of supporting the electrode patterns 331 and 341, the electrode wirings, and the like, and transparency capable of allowing the user to recognize an image provided by an image display device.

In consideration of the support force and the transparency described above, the first and second transparent substrates 330 and 340 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto.

The first and second electrode patterns 331 and 341 serve to generate signals at the time of being touched by the user to allow a controller to recognize a touch coordinate.

Here, the first and second electrode patterns 331 and 341 may be formed in a mesh pattern using copper (Cu), aluminum (Al), gold (Au), silver (Ag), titanium (Ti), palladium (Pd), chromium (Cr), or a combination thereof.

The touch panel 300 according to the second preferred embodiment of the present invention configured as described above includes the color bezel part 320 disposed in the bezel part region between the window substrate 310 and the first transparent substrate 330, but is not limited thereto. That is, the touch panel 300 may also include the color bezel part 320 disposed in the bezel part region between the first transparent substrate 330 and the second transparent substrate 340.

Therefore, the touch panel 300 according to the second preferred embodiment of the present invention implements various colors by mixing the colors with each other by the subtractive mixture method or the additive color mixture method through the color bezel part 320, thereby making it possible to implement the symbol and the image having various colors in the bezel part.

The touch panel according to the preferred embodiment of the present invention mixes the colors with each other by the subtractive mixture method or the additive color mixture method through the color bezel part formed in the bezel part region and having the multilayer structure, thereby making it possible to implement the symbol and the image having various colors in the bezel part.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a window substrate;
at least one transparent substrate including electrode patterns and electrode windings in a bezel part region provided on one surface thereof in one surface direction of the window substrate, the electrode windings in the bezel part region being connected to the electrode patterns; and
a color bezel part provided in the bezel part region between the window substrate and the transparent substrate.

2. The touch panel as set forth in claim 1, wherein the color bezel part has a stacked structure in which it includes a first ultraviolet (UV) absorbing layer, a first color light layer, a second color light layer, a light filter layer, a third color light layer, a second UV absorbing layer, and an overcoating layer that are sequentially disposed in one surface direction of the window substrate.

3. The touch panel as set forth in claim 2, wherein the first and second UV absorbing layers are made of a UV blocking inorganic material or a UV blocking organic material.

4. The touch panel as set forth in claim 2, wherein the light filtering layer is a filter layer for blocking blue color light.

5. The touch panel as set forth in claim 2, wherein each of the first color light layer, the second color light layer, and the third color light layer is provided in a form in which a dye having any one of a magenta color, a yellow color, and a cyan color is contained in a silver salt emulsion layer including silver salt and a binder.

6. The touch panel as set forth in claim 5, wherein the silver salt is inorganic silver salt including silver halide or organic silver salt including acetic acid silver.

7. The touch panel as set forth in claim 5, wherein the binder includes at least one selected from a group consisting of gelatin, polyvinyl alcohol (PVA), polyvinyl pyrrolidone (PVP), polysaccharides including starch, cellulose and derivatives thereof, polyethylene oxide, polyvinyl amine, chitosan, polylysine, polyacrylic acid, poly-alginic acid, poly hyaluronic acid, carboxy cellulose, or a combination thereof.

8. The touch panel as set forth in claim 2, wherein each of the first color light layer, the second color light layer, and the third color light layer is provided in a form in which any one of a red dye, a green dye, and a blue dye contained in a silver salt emulsion layer including silver salt and a binder.

9. The touch panel as set forth in claim 1, wherein the window substrate includes a window glass.

10. The touch panel as set forth in claim 9, wherein the window substrate has any one of a hard coating layer, an anti-finger layer, and an anti-glare layer or a stacked structure of a combination thereof, formed on an outer surface of the window glass.
